(19) United States
(12) Patent Application Publication
(10) Pub. No.: US 2002/0152310 A1
(43) Pub. Date: Oct. 17, 2002

(54) Method and apparatus to dynamically determine the optimal capacity of a server in a server farm

(75) Inventors: Vinit Jain, Austin, TX (US); Satya Prakesh Sharma, Austin, TX (US); Vasu Vallabhaneni, Austin, TX (US)

Correspondence Address: Duke W. Yee, Carstens, Yee & Cahoon, LLP,, P.O. Box 802334, Dallas, TX, 75380, US

(73) Assignee: International Business Machines Corporation, Armonk, NY (US)

(21) Appl. No.: 09/833,420

(22) Filed: Apr. 12, 2001

(51) Int. Cl. G06F 15/173

(52) U.S. Cl. 709/226; 709/223

(57) ABSTRACT

A method, apparatus, and computer implemented instructions for determining an optimal capacity of a server within a set of servers. Resource use and units of work data are dynamically collected from the server. An optimal capacity is identified for the server using the resource use and unit of work data from the server.

### BACKGROUND OF THE INVENTION

1. Technical Field

The present invention relates generally to an improved data processing system, and in particular to a method and apparatus for handling requests in a data processing system. Still more particularly, the present invention provides a method, apparatus, and computer implemented instructions for determining an optimal capacity of a data processing system for handling requests.

2. Description of Related Art

The Internet, also referred to as an “internetwork”, is a set of computer networks, possibly dissimilar, joined together by means of gateways that handle data transfer and conversion of messages from one protocol (e.g., that of a sending machine) to another protocol (e.g., that of a receiving machine) and vice versa. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Informational guides and/or searchable databases of online public records also have been provided and may reduce operating costs of these governmental agencies. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML).

In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”.

A Web browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet is widely used to transfer applications to users using browsers. The Internet also is used for commerce on the Web in which individual consumers and business use the Web to purchase various goods and services. In fact, some companies offer goods and services solely on the Web while others use the Web to extend their reach.

With respect to these commercial activities and others, businesses and other content providers employ servers to process requests from different users. Various architectures are employed in handling these requests. Often, distributed architectures in which a set of servers in a cluster or server farm is used to handle the requests. In such a system, the set of servers appears to the user as a single server, also referred to as a “virtual” server. A load balancing mechanism is used to send requests directed to the virtual server to different real servers within the set of servers. Currently, load balancing between these servers is performed statically. For example, the distribution of work load between servers in a set may be based on the number of processors within a server. For example, if a first server contains four processors, a second server contains two processors, and a third server contains one processor, work load may be distributed proportionally based on the number of processors. Allocation of work may be performed in other ways, such as, for example, based on processor speeds within a server. These types of load balancing do not always accurately reflect the ability of a server to handle work. For example, one server may execute different types of processes, which require different amounts of processor use as compared to another server.

Therefore, it would be advantageous to have an improved method, apparatus, and computer implemented instructions for determining the optimal capacity of servers for use in balancing work distributed to the servers.

### SUMMARY OF THE INVENTION

The present invention provides a method, apparatus, and computer implemented instructions for determining an optimal capacity of a server within a set of servers. Resource use and units of work data are dynamically collected from the server. An optimal capacity is identified for the server using the resource use and unit of work data from the server.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a server farm in accordance with a preferred embodiment of the present invention;

FIG. 3 is a block diagram of a data processing system in which the present invention may be implemented;

FIG. 4 is a flowchart of a process used for determining the optimal capacity of a server within a set of servers in accordance with a preferred embodiment of the present invention; and

FIG. 5 is a flowchart of a process used for load balancing in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, fiber optic cables, and the like.

In the depicted example, a server farm 104 is connected to network 102 along with storage unit 106. Server farm 104 in these examples is a set of servers, which is presented as a single server or a “virtual” server for processing requests. In addition, clients 108, 110, and 112 also are connected to network 102. These clients 108, 110, and 112 may be, for example, personal computers or network computers. In the depicted example, server farm 104 provides data, such as boot files, operating system images, and applications to clients 108-112. Clients 108, 110, and 112 are clients to server farm 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

The mechanism of the present invention provides an improved method, apparatus, and computer implemented instructions for determining the optimal capacity of a server within a server farm, such as server farm 104. More specifically, the mechanism of the present invention collects data, such as resource use data and unit of work data from a server within server farm 104. The optimal capacity for this server is identified using the collected data. Resource use data may include, for example, processor usage within the server, memory usage of the server, and bandwidth usage by the server. The unit of work data may include, for example, the number of connections established by client devices to the server or the number of data packets processed by the server.

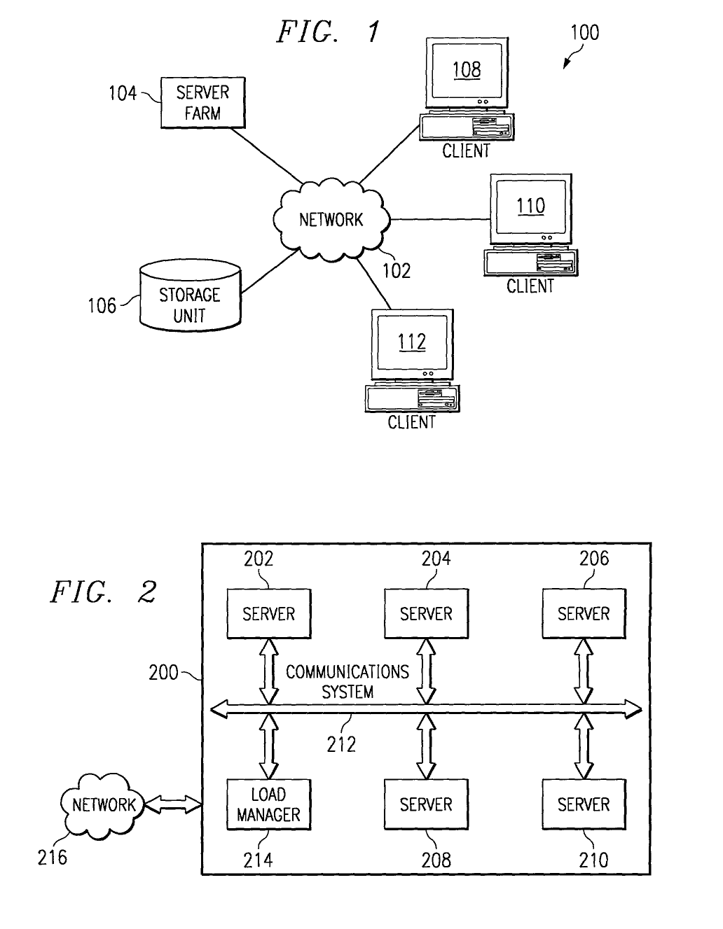

With reference now to FIG. 2, a block diagram of a server farm is depicted in accordance with a preferred embodiment of the present invention. Server farm 200 in this example may be implemented using server farm 104 in FIG. 1.

In this example, servers 202-210 are in communication with each other through communications system 212, which may take various forms. Communications system 212 may be, for example, a bus, a network, a shared memory, or the like. Communications system 212 is used to handle routing of requests and responses directed towards server farm 200. Load manager 214 also is connected to communications system 212 and serves to receive requests directed to server farm 200 from network 216. Load manager 214 also serves to distribute requests to servers 202-210 for processing.

In these examples, one of the servers from servers 202-210 acts as a master server to execute the processes used to dynamically determine the optimal capacity of servers within server farm 200. For example, if server 202 is acting as the master server, this server will collect data, such as resource use data and unit of work data from servers 204-210, as well as this same data from itself.

This approach allows a server to be added or removed from server farm 200 and have that change taken into account by the master server within server farm 200 when the master server determines server capabilities and workload balance. When a server is added to server farm 200, the optimal capacity of this added server is identified. When a server is removed from server farm 200, the capacity of the removed server is no longer determined. These changes are used a by load balancing mechanism, such as load manager 214, to distribute requests to servers within server farm 200. These requests are requests received from clients and may include, for example, requests for Web pages, files, and other content.

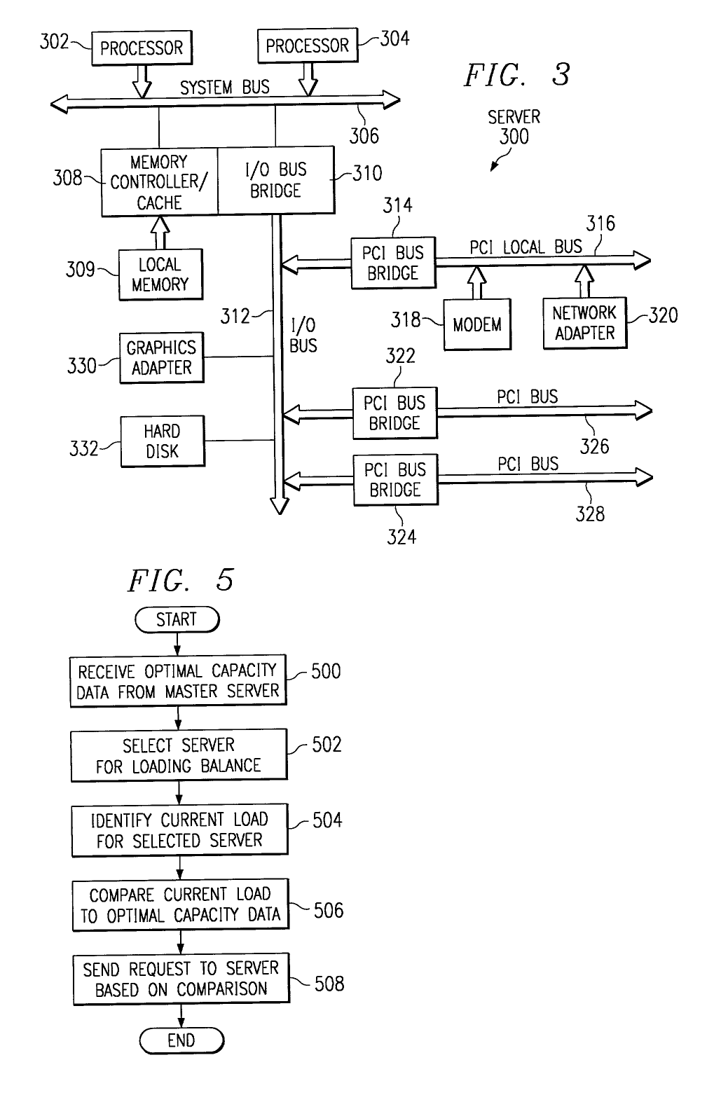

Referring to FIG. 3, a block diagram of a data processing system that may be implemented as a server, such as server 202 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to network computers 108-112 in FIG. 1 may be provided through modem 318 and network adapter 320 connected to PCI local bus 316 through add-in boards.

Additional PCI bus bridges 322 and 324 provide interfaces for additional PCI buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM RISC/System 6000 system, a product of International Business Machines Corporation in Armonk, N.Y., running the Advanced Interactive Executive (AIX) operating system.

The present invention provides a method, apparatus, and computer implemented instructions for determining an optimal capacity of a server in a server farm, such as server farm 200 in FIG. 2. In this example, data processing system 300 may be implemented as a master server to collect data and to determine the optimal capacity of servers within the server farm. As the master server, data processing system 300 collects data from the other servers to determine the optimal capacity of the servers. The data used is these examples is resource use and unit of work information as described above.

For example, in FIG. 2 server farm 200 is a server farm containing five servers. In this depicted example, server 202 acts as the master server and collects data from servers 204-210, as well as data from itself. This data is collected dynamically from servers 202-210. In these examples, the data takes into account resource use data, including processor usage of the various servers within server farm 200, memory usage of these servers, and bandwidth usage by the servers. The unit of work data includes the number of connections established between server 202-210 and various client devices. Alternatively, the number of data packets processed by a server may be taken into account in collecting the unit of work data. The optimal capacity of server farm 200 is used to alter or modify load balancing perform by load manager 214.

If server 204 is removed from server farm 200, only four servers will remain in server farm 200. Further, data from server 204 is no longer collected by server 202, the master server, in identifying the optimal capacity of server farm 200. If an additional server is added to server farm 200, six servers are now present in server farm 200. Server 202 will now collect data from this new server in determining the optimal capacity of server farm 200. This approach also allows a server to be added or removed from the server farm and have that change be taken into account. When a server is added, the optimal capacity of that server is identified. When a server is removed, the capacity of that server is no longer determined. These changes are used by a load balancing mechanism to distribute requests to the servers. The load balancing mechanism used may be any known mechanism. The present invention uses or alters the load balancing mechanism such that the load balancing mechanism reallocates distribution of work whenever changes in capacity are sent to the load balancing mechanism.

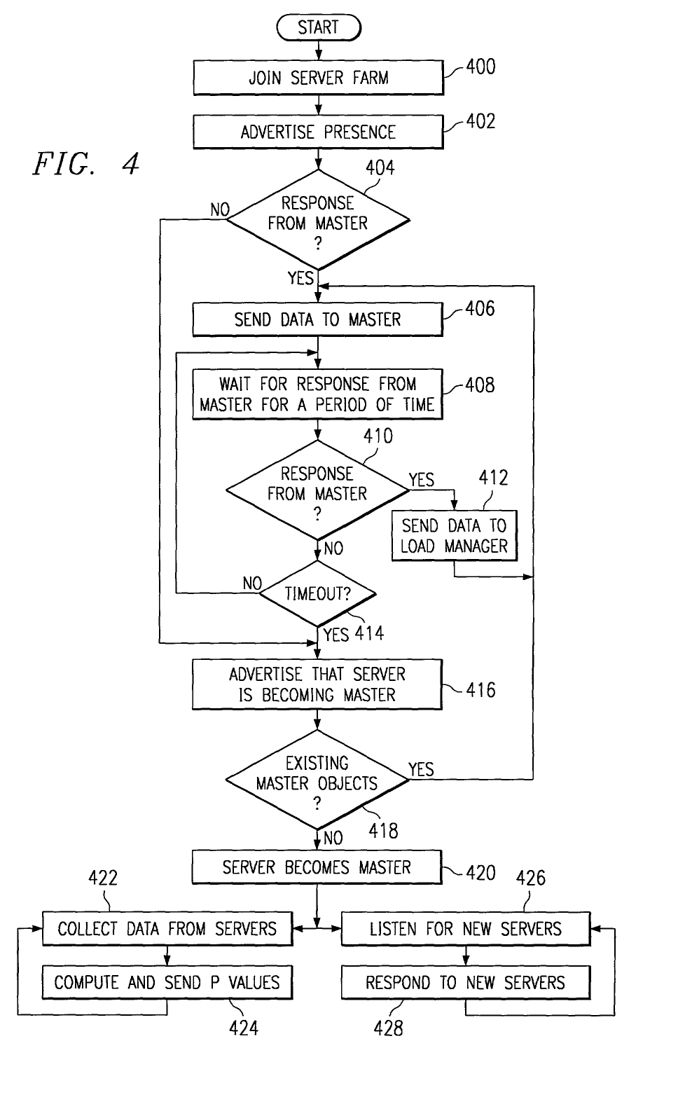

Turning next to FIG. 4, a flowchart of a process used for determining the optimal capacity of a server within a set of servers is depicted in accordance with a preferred embodiment of the present invention. The process illustrated in FIG. 4 may be implemented in a server, such as server 202 in FIG. 2.

The process begins by the server joining a server farm (step 400). The presence of the server is advertised or broadcast (step 402). This presence may be advertised by sending a message to a particular address or by generally broadcasting a message. In the depicted examples, the broadcast mechanism is employed as the fastest/cheapest way to send a message to all servers. A broadcast may be heard by other systems besides the servers on the same physical link, but is ignored by these other systems.

A determination is made as to whether a response has been received from a master server (step 404). In these examples, one server, typically within the set of servers in the server farm, functions as the master server to determine the optimal capacity of servers within the server farm. The response that is looked for is one from the master server returned in response to the advertisement of the presence of the server in which the process in FIG. 4 executes.

If a response is received from the master, data is sent from the newly joining server to the master server (step 406). In the depicted examples, the data includes resource use data and unit of work data. For example, this data may be the amount of resource used and unit of work performed since the last time data was sent to the master server. The server then waits for a period of time for a response from the master server (step 408). After that period of time, a determination is made as to whether a response has been received from the master server (step 410). This response contains data identifying the optimal capacity for the server. In this example, the optimal capacity for the server is expressed as a percentage of the total capacity of the entire system. If a response is received, the data in the response is sent to a load manager (step 412) with the process then returning to step 406 as described above. The load manager uses the data to perform a balancing of work between different servers. The data is sent to the server for forwarding to the load manager to take into account a situation which the server fails or is taken offline. If the load manager does not receive an update of the optimal capacity, this capacity is assumed to be nonexistent.

On the other hand, if a response is not received from the master server, a determination is made as to whether a timeout has occurred (step 414). This step is used to identify a situation in which the master server has failed. If a timeout has not occurred, the process returns to step 408. Otherwise, the server advertises or sends a message that it will take the place of the master server (step 416). A determination is made as to whether an existing master server objects (step 418). An objection occurs if an existing master server is still present. For example, the server on which the process illustrated in FIG. 4 is executing may not receive a response from a master server in step 404 even though the master server is still present. This may occur if the response is dropped or if a timeout occurs before the response is received from the master server. An absence of a response may occur if no response is received from the master server in response to the server advertising its presence within some timeout value. If an objection occurs, the process returns to step 406 as described above.

If an objection is not received, the server becomes the master server (step 420). In these examples, each of the servers within the server farm include instructions or other software processes to allow the server to perform the functions of a master server. As the master server, this server will advertise the fact that it is now the master server. Next, data is collected from servers in the server farm (step 422). As described above, this data includes resource use data and unit of work data in the illustrated examples. Processor usage by the servers, memory usage by the servers, and bandwidth usage by the servers are some examples of resource use data. The unit of work data may be, for example, the number of connections established between clients and a server, or the number of data packets processed by the server. This data may be collected by using various mechanisms, such as polling the servers or having the servers send the information without prompts from the master server.

The optimal capacity for each server is calculated based on data received from each of the servers in the server farm and the optimal capacity for a server is returned as a P value (step 424) with the process returning to step 422 as described above. In this example, the optimal capacity of the server is expressed as a percentage of the entire system. The optimal capacity of a server is calculated as follows:

Ei=Di1/Di2

Ri=Ei/(E1+E2 . . . En)

Pi=Ri* 100

Ei is the efficiency of server i, Ri is the relative efficiency of server i, Pi is the optimal capacity of server i expressed as the percentage of the total system, and n represents the number of servers in the system. Di1 is the average number of units of work handled by server i since the last time data was sent to the master server and Di2 is the average resource use for server i since the last time data was sent to the master server. Di1 and Di2 are not fractions. These two variables can have any units. The Ri will cancel out the units used to make it a fraction. Servers, which do not send data to the master server, are assumed to be unavailable and are ignored by the master server in these calculations.

Further from step 420, the server listens for new servers (step 426), and provides a response to new servers identifying it as the master server (step 428) with the process returning to step 426. Steps 422 and 424 form one thread, while steps 426 and 428 form a second thread with these threads running concurrently or through time slicing.

Turning back to step 404, if a response is not received by the master server the process proceeds to step 416 as described above.

Turning next to FIG. 5, a flowchart of a process used for load balancing is depicted in accordance with a preferred embodiment of the present invention. The process illustrated in FIG. 5 may be implemented in a load manager, such as load manager 214 in FIG. 2. Load balancing is the fine tuning of network to more evenly distribute the data and/or processing across available resources. For example, in clustering, load balancing might distribute the incoming transactions evenly to all servers, or it might redirect them to the next available server. In these examples, load balancing is performed by sending requests to servers in which the actual load is less than the optimal capacity identified for that server using the processes of the present invention.

The process begins by receiving optimal capacity data from the master server (step 500). A server from the server farm is selected for load balancing (step 502). Next, a current load on the selected server is identified (step 504). The current load is compared to the optimal capacity data (step 506). Requests are sent to the selected server based on the comparison (step 508) with the process terminating thereafter. This process is performed for each server within the server farm. This comparison may be made simultaneously for all servers or in a cycle in which each server is analyzed in a round-robin fashion.

Thus, the present invention provides an improved method, apparatus, and computer implemented instructions for determining the optimal capacity of a server within a set of servers. The mechanism allows the distribution of requests to a virtual server to be reallocated to real servers on a dynamic basis. This distribution of requests, such as requests for connections are based on optimal capacity received as feedback from real servers. This feedback is typically received on a periodic basis, but may be in response to an event, such as, the receipt of a selected number of requests or a particular type of request. The mechanism allows one server to become a master server for the group. Alternatively, the master server may be a separate computer system.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although a server farm is illustrated in which the mechanism of the present invention is implemented, the mechanism may be implemented in other types of architecture in which load balancing is required for a set of servers. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for determining an optimal capacity of a server within a set of servers, the method comprising:
dynamically collecting resource use and units of work data from the server; and
identifying the optimal capacity for the server using the resource use and unit of work data from the server.

2. The method of claim 1 further comprising:
directing connection requests to servers within the set of servers using the optimal capacity for the server.

3. The method of claim 1, wherein the resource use and unit of work data is collected in response to an event.

4. The method of claim 3, wherein the event is a periodic event.

5. The method of claim 1, wherein optimal capacity is identified as follows:
Ei=Di1/Di2
Ri=Ei/(E1+E2 . . . En)
Pi=Ri * 100
wherein, Ei is an efficiency of server i; Ri is a relative efficiency of server i; Pi is the optimal capacity of server i; n is a number of servers in the set of servers; Di1 is an average number of units of work handled by server i since the last time data was sent to the data processing system; and Di2 is an average resource use for server i since the last time data was sent to the data processing system.

6. The method of claim 1, wherein the set of servers are located in a local area network.

7. The method of claim 1, wherein the set of servers are a set of virtual servers located on the data processing system.

8. The method of claim 1, wherein the resource use includes at least one of processor use, memory use, and bandwidth use.

9. The method of claim 1, wherein the unit of work data includes at least one of a number of packets and a number of connections.

10. The method of claim 1 further comprising:
sending the optimal capacity to the server.

11. The method of claim 10 further comprising:
sending, by the server, the optimal capacity to a load balancer, wherein the load balancer directs connection requests to the set of servers using the optimal capacity.

12. A method in a data processing system for determining an optimal capacity of the data processing system server, the method comprising:
tracking resource use and units of work since a last collection of resource use and units of wok data from a server;
sending the resource use and units of work performed data to a server in response to an event; and
receiving an identification of an optimal capacity from the server in response to sending the resource use and units of work performed data.

13. The method of claim 12 further comprising:
sending the identification received from the server to a load balancer.

14. The method of claim 12, wherein the resource use includes at least one of processor use, memory use, and bandwidth use.

15. The method of claim 12, wherein the units of work includes at least one of a number of packets and a number of connections.

16. The method of claim 12, wherein the server identifies optimal capacity for a set of servers including the data processing system and further comprising:
responsive to an absence of a reception of an identification of the optimal capacity within a selected amount of time, initiating a process to replace the server and perform identifications of optimal capacity for the set of servers.

17. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to dynamically collect resource use and units of work data from the server; and identify an optimal capacity for the server using the resource use and unit of work data from the server.

18. The data processing system of claim 17, wherein the bus system includes a primary bus and a secondary bus.

19. The data processing system of claim 17, wherein the processor unit includes a single processor.

20. The data processing system of claim 17, wherein the processor unit includes a plurality of processors.

21. The data processing system claim 17, wherein the communications unit is an Ethernet adapter.

22. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to track resource use and units of work since a last collection of resource use and units of wok data from a server; send the resource use and units of work performed data to the server in response to an event; and receive an identification of an optimal capacity from the server in response to sending the resource use and units of work performed data.

23. A data processing system for determining an optimal capacity of a server within a set of servers, the data processing system comprising:
collecting means for dynamically collecting resource use and units of work data from the server; and
identifying means for identifying an optimal capacity for the server using the resource use and unit of work data from the server.

24. The data processing system of claim 23 further comprising:
directing means for directing connection requests to servers within the set of servers using the optimal capacity for the server.

25. The data processing system of claim 23, wherein the resource use and unit of work data is collected in response to an event.

26. The data processing system of claim 25, wherein the event is a periodic event.

27. The data processing system of claim 23, wherein optimal capacity is identified as follows:
Ei=Di1/Di2
Ri=Ei/(E1+E2 . . . En)
Pi=Ri * 100
wherein, Ei is an efficiency of server i; Ri is a relative efficiency of server i; Pi is the optimal capacity of server i; n is a number of servers within the set of servers; Di1 is an average number of units of work handled by server i since the last time data was sent to the data processing system; and Di2 is an average resource use for server i since the last time data was sent to the data processing system.

28. The data processing system of claim 23, wherein the set of servers are located in a local area network.

29. The data processing system of claim 23, wherein the set of servers are a set of virtual servers located on the data processing system.

30. The data processing system of claim 23, wherein the resource use includes at least one of processor use, memory use, and bandwidth use.

31. The data processing system of claim 23, wherein the unit of work data includes at least one of a number of packets and a number of connections.

32. The data processing system of claim 23 further comprising:
first sending means for sending the optimal capacity to the server.

33. The data processing system of claim 32, wherein the sending means is a first sending means and further comprising:
second sending means for sending, by the server, the optimal capacity to a load balancer, wherein the load balancer directs connection requests to the set of servers using the optimal capacity.

34. A data processing system for determining an optimal capacity of the data processing system server, the data processing system comprising:
tracking means for tracking resource use and units of work since a last collection of resource use and units of wok data from a server;
first sending means for sending the resource use and units of work performed data to the server in response to an event; and
receiving means for receiving an identification of an optimal capacity from the server in response to sending the resource use and units of work performed data.

35. The data processing system of claim 34, wherein the sending means is a first sending means and further comprising:
second sending means for sending the identification received from the server to a load balancer.

36. The data processing system of claim 34, wherein the resource use includes at least one of processor use, memory use, and bandwidth use.

37. The data processing system of claim 34, wherein the units of work includes at least one of a number of packets and a number of connections.

38. The data processing system of claim 34, wherein the server identifies optimal capacity for a set of servers including the data processing system and further comprising:
initiating means, responsive to an absence of a reception of an identification of an optimal capacity within a selected amount of time, for initiating a process to replace the server and perform identifications of optimal capacity for the set of servers.

39. A computer program product in a computer readable medium for determining an optimal capacity of a server within a set of servers, the computer program product comprising:
first instructions for dynamically collecting resource use and units of work data from the server; and
second instructions for identifying the optimal capacity for the server using the resource use and unit of work data from the server.

40. A computer program product in a computer readable medium for determining an optimal capacity of the data processing system server, the computer program product comprising:
first instructions for tracking resource use and units of work since a last collection of resource use and units of wok data from a server;
second instructions for sending the resource use and units of work performed data to the server in response to an event; and
third instructions for receiving an identification of an optimal capacity from the server in response to sending the resource use and units of work performed data.
